(19) United States
(12) Patent Application Publication
(10) Pub. No.: US 2026/0249345 A1
(43) Pub. Date: Aug. 27, 2026

(54) JOINTS WITH HIGH VELOCITY INDUCED METALLURGICAL BONDS

(71) Applicant: Battelle Memorial Institute, Richland, WA (US)

(72) Inventors: Vineet V. Joshi, Richland, WA (US); Benjamin J. Schuessler, Kennewick, WA (US); Mark A. Rhodes, Kennewick, WA (US); Daniel Ramirez Tamayo, Spring, TX (US); Lei Li, Richland, WA (US); Nicole R. Overman, Kennewick, WA (US); Timothy W Skszek, Saline, MI (US); Darrell R. Herling, Kennewick, WA (US); Kevin L. Simmons, Kennewick, WA (US); Daniel R. Merkel, West Richland, WA (US); Yongsoon Shin, Richland, WA (US); Yao Qiao, Richland, WA (US)

(21) Appl. No.: 19/060,745

(22) Filed: Feb. 23, 2025

(51) Int. Cl. B21J 15/04; B21J 15/02; B21J 15/16; B27F 7/05

(52) U.S. Cl. CPC B21J 15/04; B21J 15/027; B21J 15/16; B27F 7/05

(57) ABSTRACT

Methods and apparatuses join multiple members with a high velocity induced metallurgical bond. An example method includes accelerating a projectile to a threshold velocity toward members in stacked relation to one another and striking a first member of the members at or above a threshold velocity with the projectile to form a joint that couples the members to one another. The threshold velocity is sufficient to induce a metallurgical bond in the joint.

### STATEMENT AS TO RIGHTS TO DISCLOSURES MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND

Various industries employ machines, structures and other apparatuses that include multiple structural or other components connected to one another via various joining methods that need to withstand various conditions in use for various reasons, including minimizing maintenance, strength, longevity, and safety. Additionally, a variety of factors are driving some such industries to form such machines and other apparatuses of an increasing variety of disparate materials in efforts to improve costs, strength or other performance characteristics, as well as improve environmental factors such as energy consumption (also a cost factor) and end-of-life recyclability.

The automotive, trucking, infrastructure and aerospace industries, for example, manufacture machines that include multiple components, commonly of differing materials joined together and required to reliably withstand relatively high loading conditions, have low maintenance requirements, and be produced efficiently. The scale of production and/or total costs of manufacturing and the number of joints required to manufacture complex machines like cars, trucks, and airplanes, as well as the performance requirements of such machines makes the methods of joining and the joints created thereby an important factor in the automotive and aerospace, as well as various other industries.

### SUMMARY

The present inventors have conceived, among other things, methods and apparatuses for joining multiple members with a high velocity process which induces a metallurgical bond due to adiabatic shear instability and/or frictional forces. Examples according to this disclosure include joints formed by accelerating one or more projectiles to high velocities and impacting and deforming, and, in some examples, penetrating and/or piercing a stack of multiple members (e.g., sheets, blocks, billets or material samples in other forms). The high velocity interaction of the projectile(s) and material members at the joint site produces a shear velocity and pressure between the projectile and material surfaces resulting in adiabatic shear instability and/or high frictional forces and joint interfacial temperatures and pressures that induce microstructure recrystallization at the interface. Example joints having high velocity induced metallurgical bonds exhibit high strength and other advantageous characteristics and can be produced at scale at relatively low costs with relatively low energy inputs. Additionally, example joints and apparatuses and methods for producing them can be used on a variety of materials and to connect dissimilar materials to one another. Moreover, example methods and apparatuses for joining multiple members according to this disclosure can produce high strength joints without pre-processing steps such as surface preparation, pre-drilling holes, heat input (e.g. heat treatment), as examples.

Examples according to this disclosure include joints and apparatuses and methods for forming joints that couple multiple members with or without a fastener in the joint. In examples, fastenerless joints that couple multiple members can be formed with a high velocity driven clinch method and apparatus. In other examples, fastener joints that couple multiple members can be formed with a high velocity driven nailing or riveting method and apparatus. In all examples according to this disclosure, the joints include metallurgical bonds that may exhibit substantial improvements in relevant joint characteristics over and notably may also be produced in less time, at lower cost, and with less resources than joints produced with current methods, including, e.g., spot welding (including resistance spot welding), mechanical fasteners, flow drill screw, self-piercing riveting, and clinching methods.

Examples according to the present application can include accelerating a projectile to a threshold velocity toward a first member of a plurality of members arranged in stacked relation and striking the first member at or above the threshold velocity with the projectile to form a joint that couples the plurality of members to one another. The joint that couples the plurality of members to one another includes a high velocity induced metallurgical bond that exhibits advantageous strength and reliability produced in relatively short cycle times, at relatively low costs, and with relatively low resource inputs.

This overview is intended to provide an overview of subject matter in the present application. It is not intended to provide an exclusive or exhaustive explanation of the invention. The detailed description is included to provide further information about the present application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a flowchart depicting an example method of joining multiple members to one another with a metallurgical bond.

FIG. 2 schematically depicts an example apparatus joining multiple members to one another with a metallurgical bond.

FIGS. 3A-3B depict another example apparatus joining multiple members to one another with a metallurgical bond.

FIGS. 4A-4D depict another example apparatus joining multiple members to one another with a metallurgical bond.

FIGS. 5A-5B depict another example apparatus joining multiple members to one another with a metallurgical bond.

FIGS. 6A-6C depict another example apparatus joining multiple members to one another with a metallurgical bond.

FIGS. 7A-7B depict another example apparatus joining multiple members to one another with a metallurgical bond.

### DETAILED DESCRIPTION

The present application relates to methods and apparatuses for joining multiple members with high velocity induced metallurgical bonds caused by adiabatic shear instability and/or frictional forces at the joint interface between the members. The high velocity interaction of projectile(s) and material members at a joint site between the members produces a shear velocity between the projectile(s) and member surfaces resulting in adiabatic shear instability and/or high frictional forces and joint interfacial temperatures and pressures that cause microstructure recrystallization at the interface. Example joints having high velocity induced metallurgical bonds exhibit high strength and other advantageous characteristics and can be produced at scale at relatively low costs with relatively low energy inputs.

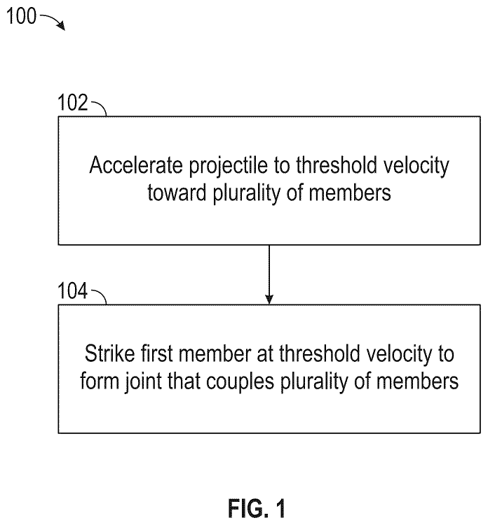

FIG. 1 is a flowchart depicting example method 100 of joining multiple members to one another with a metallurgical bond. Example method 100 includes accelerating a projectile to a threshold velocity toward a plurality of members in stacked relation to one another (102) and striking a first member of the plurality of members at the threshold velocity with the projectile to form a joint that couples the plurality of members to one another (104). The threshold velocity of the projectile is sufficient to induce a metallurgical bond in the joint between the plurality of members.

The form, number, and materials of the plurality of members joined in example method 100 can vary. For example, the members can include sheets cast, extruded or other form of components coupled to one another. Additionally, the plurality of members can include two, three, or more members connected to one another in accordance with example method 100. The plurality of members can be formed from the same or different materials. For example, the plurality of members can include members formed from the same or different metals and metallic alloys, e.g., aluminum or steel and/or alloys thereof. Additionally, one of the members can be formed from a metal or metallic alloy and another of the members can be formed from a composite.

The members are in stacked relation to one another, which can arrange each member such that the member has at least one surface abutting a surface of another member at an interface. For example, in a stack of two members, a first member has a first surface abutting a first surface of the second member at an interface between the two members. In this example, the striker can strike a second surface of the first member opposite the first surface and the joint, including the metallurgical bond can be formed at the interface of the first surfaces of the first and second members, i.e. at the interface between the two members.

In an example including a stack of three members, a first member (e.g. top member) has a first surface abutting a first surface of a second member at a first interface between the first and second members, and the second member (e.g. middle member) has a second surface (opposite the first surface of the second member) abutting a first surface of a third member (e.g. bottom member) at a second interface between the second and third members. In this example, the striker can strike a second surface of the first member opposite the first surface and the joint, including the metallurgical bond can be formed at the interface of the first surfaces of the first and second members, i.e. at the first interface between the first and second members, and/or at the interface of the second surface of the second member and the first surface of the third member, i.e. at the second interface between the second and third members. In example method 100 (and other example methods and apparatuses according to this disclosure), the joint and the metallurgical bond of the joint can thus include/be formed in different interfacial regions of the plurality of members, including, e.g., surficial interfaces between pairs of members of the plurality of members.

Example method 100 can join the plurality of members with or without a fastener. In examples, the projectile can include a striker that joins the plurality of members without a fastener, which is sometimes referred to as a clinch method/clinch joint. In examples, the projectile can include a striker and fastener. The striker and fastener can be arranged adjacent to and accelerated together to the threshold velocity toward the first member of the plurality of members. In examples, the fastener can include a rivet or a nail, as examples. The fastener, regardless of form or type, can penetrate and/or pierce one or more of the plurality of members. Additionally, in examples including a fastener, the joint including the metallurgical bond can include/be formed in, e.g. one or more surficial interfaces between the fastener and one or more of the plurality of members and/or one or more surficial interfaces between different ones of the plurality of members.

The projectile can include a striker, which can include a variety of material masses employed to transfer energy from a prime mover to the plurality of members to form the metallurgically bonded joint. The projectile, including, e.g., a striker with or without a fastener can be accelerated to the threshold velocity employing a variety of prime movers and, in some examples, with the aid of a guide. Example prime movers can include explosive or other pressure release mechanisms, electromagnetic, and electrohydraulic prime movers. In examples, the prime mover can include a powder-actuated shell or a gas gun arranged to deliver an impulsive load to accelerate a piston or other striker without or along with a fastener toward the plurality of members. In such an example, the piston striker without or along with a fastener can be guided toward the plurality of members in a cylinder. In examples, the cylinder or other projectile guide can also function to hold the plurality of members, e.g., clamped between the guide and a backing die.

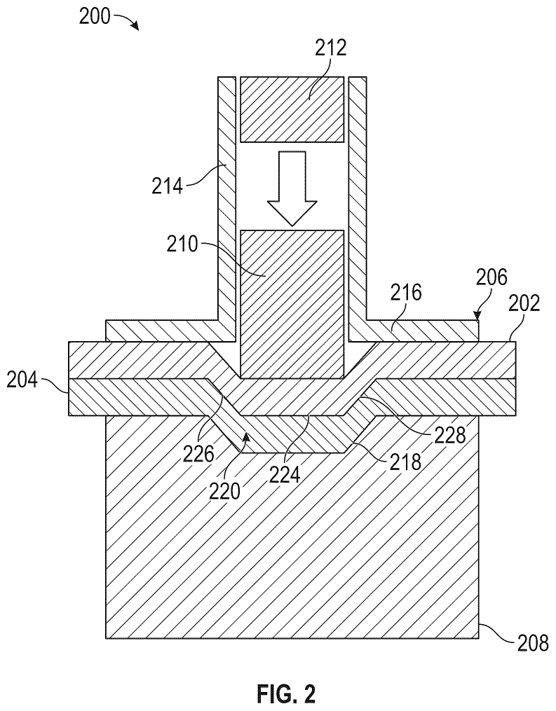

As an illustrative example of method 100 (and other methods according to this disclosure), FIG. 2 schematically depicts example apparatus 200 for joining a plurality of members, in this example, first member 202 and second member 204. In examples, example method 100 of FIG. 1 can be conducted using apparatus 200. Apparatus 200 includes holder 206 and backing die 208 between which first and second members 202, 204 are clamped.

Holder 206 can be a cylinder that also functions to guide projectile 210 accelerated by prime mover 212 to a threshold velocity toward first and second members 202, 204. As depicted, holder 206 can include cylinder 214 in which projectile 210 is arranged and by which the projectile is guided, and base (may also be referred to as shoulder) 216 by which first and second members 202, 204 are clamped between holder 206 and backing die 208.

Backing die 208 can take a variety of forms and, as depicted in the example of FIG. 2 can include depression 218, into which portions of first and second members 202, 204 are sheared in the formation of a metallurgically bonded joint therebetween. The geometry of depression 218 in backing die 208 (and other backing dies in examples according to this disclosure) can vary depending upon a number of factors and, as will be described in more detail below, can be optimized to improve characteristics of metallurgically bonded joints between members, e.g. first and second members 202, 204.

Projectile 210 in the example of FIG. 2 includes a cylindrical striker. Apparatus 200 of the example of FIG. 2 is adapted to form a fastenerless clinch joint between first and second members 202, 204. Example apparatus 200 is merely illustrative of apparatuses that may be employed according to example method 100 and additional apparatuses also suitable for example method 100 (and other methods according to this disclosure) are described below, including apparatuses employing a projectile including a striker and fastener, e.g. a nail or rivet.

First and second members 202, 204 can be formed from the same or different materials. For example, first and second members 202, 204 can include members formed from the same or different metals and metallic alloys, e.g., aluminum or steel and/or alloys thereof. Additionally, one of the members can be formed from a metal or metallic alloy and another of the members can be formed from a composite. In examples, first and second members 202, 204 can include a material selected from the group of materials consisting of metals, polymers, composites, and combinations thereof.

In examples, prime mover 212 accelerates projectile 210 to a threshold velocity toward first and second members 202, 204 in stacked relation to one another (102). Projectile 210 strikes first member 202 at or above the threshold velocity to form joint 220 that couples first and second members 202, 204 to one another (104). The threshold velocity of projectile 210 is sufficiently high to induce a metallurgical bond in joint 220 between first and second members 202, 204.

The “high” velocity that induces metallurgical bonds can vary in different examples according to this disclosure but is not an unbound or absolutely relative magnitude of velocity. In examples, the velocity is a threshold magnitude sufficient to induce a metallurgical bond between one of more of the members being joined. For example, the threshold velocity can be greater than a ballistic limit of each of the members being joined and less than a cavitation limit of each of the members. Additionally, the present inventors have recognized that while this example range of velocities can be sufficient to induce a metallurgical bond, improvements in the strength, extent, continuity and/or other advantageous characteristics of the bond may be improved by narrower ranges of velocities. For example, substantially more than the ballistic limit and substantially less than the cavitation limit of the members being joined may induce improved metallurgical bonds.

The threshold velocity can be, for example, in a range from approximately 40 meters per second (131.2 feet per second) to approximately 250 meters per second (820.2 feet per second). In this range of velocities, the metallurgical bond formed at the joint interfaces of one of more of the members being joined may be caused by adiabatic shear instability and/or friction forces at the interface versus, e.g., explosive bonding due to the jetting phenomenon at velocities above the upper limit of this range and other mechanisms at velocities below the lower limit. Additionally, the metallurgical bond induced at these velocities my exhibit advantageous characteristics relative to bonds induced by velocities outside this range.

For example, the extent of joint 220 along a surficial interface between first and second members 202, 204 may vary with the threshold velocity selected for projectile 210. For example, at velocities of projectile 210 below 40 meters per second (131.2 feet per second), a metallurgical bond may be formed only at bottom portion 224 or both of opposite side portions 226, 228 of the surficial interface between first and second members 202, 204. In examples, at velocities in a range from approximately 40 meters per second (131.2 feet per second) to approximately 250 meters per second (820.2 feet per second), the metallurgical bond between first and second members 202, 204 may have improved continuity and extent, e.g. may be formed along more of or all of bottom portion 224 and more of or all of side portions 226, 228 of the surficial interface between first and second members 202, 204.

Additional characteristics/parameters of example methods and apparatuses according to this disclosure can advantageously affect metallurgically bonded joints between members. For example, the geometry of depression 218 in backing die 208, the thickness and material of first and second members 202, 204, and/or the mass and material of projectile 210 can be varied to improve characteristics of a metallurgical joint between first and second members 202, 204.

Additionally, pre and/or post-processing including surface preparation and/or adhesives may be used in example apparatuses and methods according to this disclosure to improve characteristics of a metallurgical joint between members being joined, e.g. first and second members 202, 204. The surficial interface between members being joined can be subjected to a variety of surface preparation processes prior to joining the members. In examples, surfaces of members to be joined may undergo a plasma surface treatment during which the surfaces of the members are exposed to an ionized gas that removes contaminants from and prepares the surfaces for joining via high velocity induced metallurgical bond caused by adiabatic shear instability and/or frictional forces. In examples, the plasma surface treatment can be an atmospheric or open-air treatment or a low-pressure treatment conducted within an evacuated chamber. Other surface treatment processes may be applied to joint interfacial surfaces of members being joined in methods and by apparatuses according to this disclosure, including, e.g., laser surface treatments.

In examples, joint surficial interfaces of first and second members 202, 204 (an more generally members being joined and/or fasteners employed in the joining) may undergo a plasma surface treatment with a power of approximately 500 Watts and an air pressure of approximately 85 pounds per square inch. The plasma surface treatment can include a plasma emitter arranged and configured to direct plasma onto relevant surfaces of members being joined. The plasma emitter can, for example, include a jet applicator with a nozzle in which the plasma is generated and a jet of compressed air the directs the plasma onto the surface being treated. The plasma emitter may be positioned offset from the surface being treated and may be controlled to trace a path over an area of treatment, which may be referred to as the raster pattern.

In examples, the plasma emitter can be positioned offset from the surface being treated by in a range from approximately 0.125 to approximately 0.5 inches. In an example, the plasma emitter can be positioned offset from the surface being treated by approximately 0.125 inches. In examples, the plasma emitter can be positioned offset from the surface being treated by approximately 0.25 inches. In an example, the plasma emitter can be positioned offset from the surface being treated by approximately 0.5 inches.

In examples, the plasma emitter may trace a raster pattern in rows across the surface being treated. The plasma emitter can apply the treatment in the raster pattern at a variety of rates. In examples, the plasma emitter moves over the surface being treated at a rate in a range from approximately 2 seconds/inch to 16 seconds/inch. In examples, the plasma emitter moves over the surface being treated at a rate of approximately 4 seconds/inch. In examples, the plasma emitter moves over the surface being treated at a rate of approximately 8 seconds/inch.

In addition, or as an alternative to surface preparation, examples according to this disclosure may employ surface coating or surface modification of members being joined and/or fasteners employed in such joining to minimize corrosion byproducts and degradation of performance and/or an adhesive at the joint interface between members being joined. In examples, a variety of non-conductive structural adhesives may be applied at a joint interface of members being joined to improve one or more characteristics of the joint and/or of the metallurgical bond of the joint. In examples, a variety of thermoset adhesives and/or epoxy adhesives can be applied at a joint interface of members being joined, including in the form of pastes and tapes. In examples, a variety of epoxy resin adhesives can be employed, including epoxy resins with Bisphenol A, Acrylic polymer, Bisphenol A-Epichlorohydrin polymer, Phenol-FA polymer with glycidyl ether, Diglycidylether-bisphenol A, and Dicyandiamide.

In an example according to this disclosure, XP0012 or XP5005F thermoset adhesive supplied by L&L Products of Romeo, MI can be employed at joint surficial interfaces of members being joined. XP0012 and XP5005F are both thermoset adhesives including epoxy resin (phenolformaldehyde polymer with glycidyl ether, rubber-modified epoxy resin, and bisphenol A-epichlorohydrin polymer) and can also include proprietary curing agents and/or additional additives.

Examples with adhesive(s) at the joint interface may also employ a spacer to maintain a predetermined adhesive film thickness. For example, glass beads with, e.g., a diameter equal to a predetermined adhesive film thickness may be interposed between members being joined. Such spacers, e.g., glass beads may not be able to be employed in certain pressure/force driven processes, e.g., current riveting processes. However, as examples according to this disclosure can include an energy driven process, a fastener can be driven to penetrate and, in some cases, pierce members being joined and between which a spacer is interposed without embedding the spacer into joint interfacial surfaces of the members.

In the example of method 100 and apparatus 200 (and other example methods and apparatuses according to this disclosure), the threshold velocity of projectile 210 can be in a range from approximately 90 meters per second (295.3 feet per second) to approximately 250 meters per second (820.2 feet per second). In examples, the threshold velocity can be in a range from approximately 120 meters per second (393.7 feet per second) to approximately 175 meters per second (574 feet per second). In examples, the threshold velocity can be in a range from approximately 120 meters per second (393.7 feet per second) to approximately 150 meters per second (492.1 feet per second).

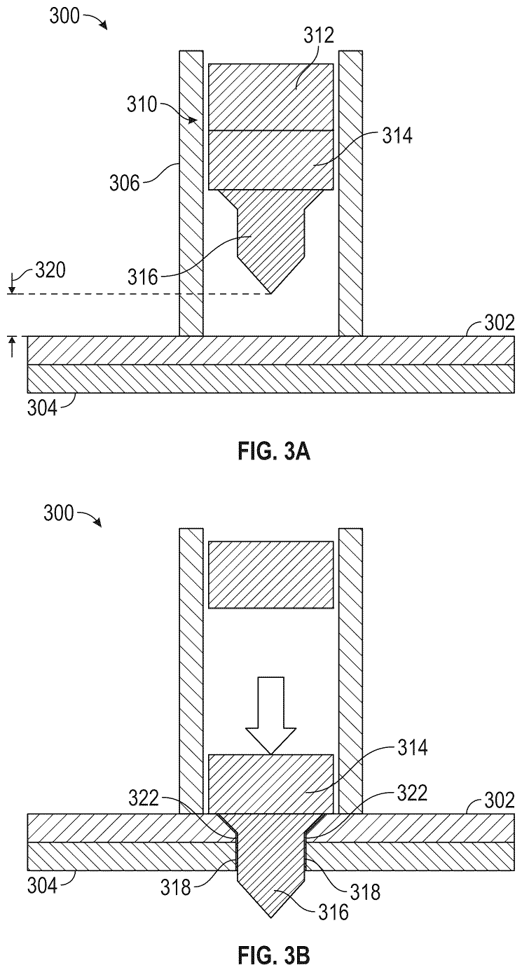

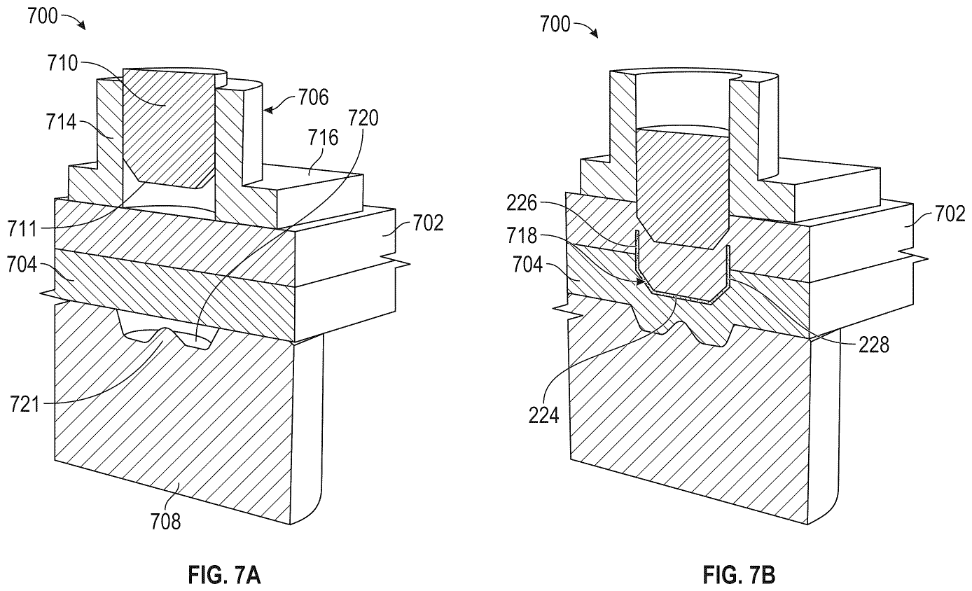

FIGS. 3A-7B depict example apparatuses for forming joints between multiple members with and without fasteners and including high velocity induced metallurgical bonds connecting the members being joined. FIGS. 3A-6C depict example apparatuses for joining members with a fastener and including high velocity induced metallurgical bonds connecting the members being joined and/or member(s) to the fastener. FIGS. 7A-7B depict an example apparatus for joining members without a fastener and including high velocity induced metallurgical bonds connecting the members being joined.

Example apparatuses for joining a plurality of members according to this disclosure include a holder, a projectile, and a prime mover. The holder can be any fixture sized, arranged, and configured to secure the members, e.g., in stacked relation to one another. In some examples, the holder also functions to retain the prime mover and/or projectile relative to the prime mover and guide the projectile to accelerate toward and strike the member(s). The prime mover can include a variety of devices, mechanisms, etc. that are configured to transfer energy to and accelerate the projectile, including, e.g., a powder-actuated shell or a gas gun arranged to deliver an impulsive load to accelerate a piston or other striker without or along with a fastener toward the plurality of members.

In examples according to this disclosure, a holder can include a cylinder (which may also be referred to as a barrel) that acts as guide for a projectile and prime mover. In examples employing an electromagnetic prime mover, the holder may be made from a material that stays decoupled from the electromagnetic field of prime mover, e.g. a glass barrel or other dielectric material.

Regardless of type, the prime mover is arranged and configured to accelerate the projectile toward the plurality of members such that the projectile strikes a first member of the plurality of members at or above a threshold velocity to form a joint that couples the plurality of members to one another. The threshold velocity at which the projectile strikes the first member is sufficient to induce a metallurgical bond in the joint.

FIGS. 3A-3B depict example apparatus 300 for joining a plurality of members, in this example, first member 302 and second member 304. In examples, example method 100 of FIG. 1 and other example methods according to this disclosure can be conducted using apparatus 300.

Apparatus 300 includes holder 306 which can be sized, arranged, and configured to secure first and second members 302, 304 in stacked relation to one another. Holder 306 can be a cylinder that also functions to guide projectile 310 accelerated by prime mover 312 to a threshold velocity toward first and second members 302, 304.

Holder 306 or some other separate or connected fixture is configured to secure first and second members 302, 304 in the example of apparatus 300. Notably, for example, apparatus 300 does not include a backing die between which first and second members 302, 304 are clamped to holder 306. This type of apparatus may be referred to as a blind or single sided nailing apparatus.

Projectile 310 in the example of FIGS. 3A-3B includes cylindrical striker 314 and nail 316. Apparatus 300 of the example of FIGS. 3A-3B is adapted to form a nailed joint between first and second members 302, 304. In the example of FIGS. 3A-3B, nail 316 is configured to pierce through first and second members 302, 304 in the formation of joint 318.

In example methods and apparatuses according to this disclosure including a striker and fastener, including the examples of FIGS. 3A-6C, the size of the striker relative to the size of the fastener and other portions of the joinery apparatus may be important. In examples, a striker can have a larger in cross-sectional area than the cross-sectional area of the fastener. The relative cross-sectional size difference between striker and fastener can function to prevent or limit penetration of the striker into the stack of members being joined. Referring again to FIGS. 3A-3B, striker 314 have a larger in cross-sectional area than the cross-sectional area of fastener 316.

First and second members 302, 304 can be formed from the same or different materials. For example, first and second members 302, 304 can include members formed from the same or different metals and metallic alloys, e.g., aluminum or steel and/or alloys thereof. Additionally, one of the members can be formed from a metal or metallic alloy and another of the members can be formed from a composite. In examples, first and second members 302, 304 can include a material selected from the group of materials consisting of metals, polymers, composites, and combinations thereof.

In examples, prime mover 312 accelerates striker 314 and nail 316 to a threshold velocity toward first and second members 302, 304 in stacked relation to one another. Nail 316 and then striker 314 strike first member 302 at a threshold velocity. It is important that projectile 310, including, in this example, striker 314 and nail 316 are at the threshold velocity when they strike first member 302. As such, in examples according to this disclosure, projectile 310, in this example, nail 316 is arranged spaced apart from first member 302 by gap 320 prior to prime mover 312 accelerating them toward first and second members 302, 204. Gap 320 is sized such that projectile 310, including striker 314 and nail 316 can accelerate from a standstill to the threshold velocity before reaching first member 302.

The threshold velocity of projectile 310 is sufficiently high to induce a metallurgical bond in joint 318 connecting first and second members 302, 304. In this example, in which nail 316 pierces through first and second members 302, 304, the metallurgical bond is formed at the interface between nail 316 and first and second members 302, 304 along joint 318. There can be a metallurgical bond therefore between nail 316 and first member 302 and/or a metallurgical bond between nail 316 and second member 304. Additionally, in some examples, during impact and piercing of first and second members 302, 304, a metallurgical bond may be formed between first and second members 302, 304, e.g. at surficial interfaces 322 of the members on either side of nail 316.

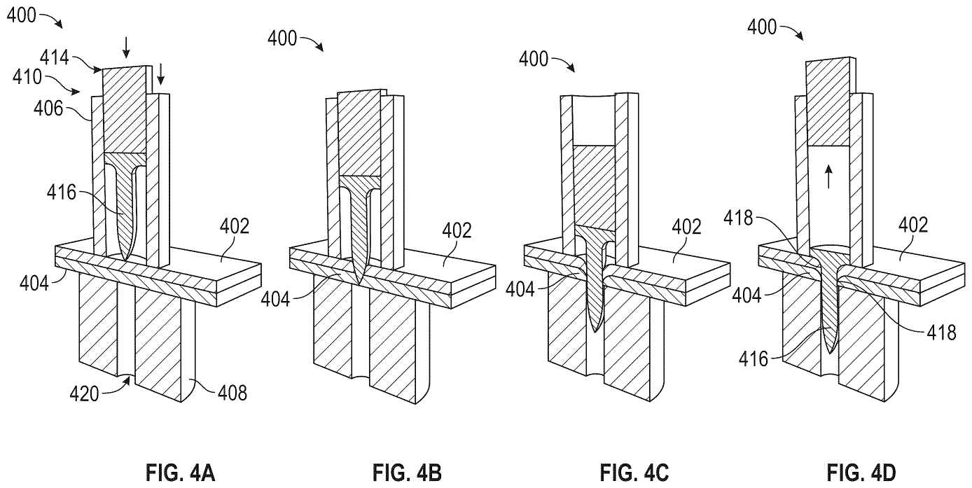

FIGS. 4A-4D schematically depict example apparatus 400 for joining a plurality of members, in this example, first member 402 and second member 404. In examples, example method 100 of FIG. 1 and other examples according to this disclosure can be conducted using apparatus 400.

Apparatus 400 includes holder 406 and backing die 408 between which first and second members 402, 404 are clamped. Holder 406 can be a cylinder that also functions to guide projectile 410 accelerated by a prime mover (not shown) to a threshold velocity toward first and second members 402, 404.

Projectile 410 in the example of FIGS. 4A-4D includes cylindrical striker 414 and nail 416. Apparatus 400 of the example of FIGS. 4A-4D is adapted to form a nailed joint between first and second members 402, 404. In the example of FIGS. 4A-4D, nail 416 is configured to pierce through first and second members 402, 404 in the formation of joint 418.

Backing die 408 can take a variety of forms and, as depicted in the example of FIGS. 4A-4D can include aperture 420, into which nail 416 is received and portions of first and second members 402, 404 are sheared in the formation of a metallurgically bonded joint therebetween. The geometry of aperture 420 in backing die 408 (and other backing dies in examples according to this disclosure) can vary depending upon a number of factors and can be varied to improve characteristics of metallurgically bonded joints between members, e.g. first and second members 402, 404. In examples, aperture 420 includes a thru-hole with a circular cross-section and the diameter of aperture 420 is greater than an outer diameter of nail 416.

First and second members 402, 404 can be formed from the same or different materials. For example, first and second members 402, 404 can include members formed from the same or different metals and metallic alloys, e.g., aluminum or steel and/or alloys thereof. Additionally, one of the members can be formed from a metal or metallic alloy and another of the members can be formed from a composite. In examples, first and second members 402, 404 can include a material selected from the group of materials consisting of metals, polymers, composites, and combinations thereof.

In examples, the prime mover accelerates striker 414 and nail 416 to a threshold velocity toward first and second members 402, 404 in stacked relation to one another. Nail 416 strikes first member 402 at a threshold velocity. It is important that projectile 410, including, in this example, striker 414 and nail 416 are at the threshold velocity when they strike first member 402. As such, although not shown in FIG. 4A, nail 416 can be arranged spaced apart from first member 402 by a gap prior to the prime mover accelerating them toward first and second members 402, 404. The gap is sized such that projectile 410, including striker 414 and nail 416 can accelerate from a standstill to the threshold velocity before reaching first member 402.

The threshold velocity of projectile 410 is sufficiently high to induce a metallurgical bond in joint 418 connecting first and second members 402, 404. In this example, in which nail 416 pierces through first and second members 402, 404, the metallurgical bond is formed at the interface between nail 416 and first and second members 402, 404 along joint 418. There can be a metallurgical bond therefore between nail 416 and first member 402 and/or a metallurgical bond between nail 416 and second member 404. Additionally, in some examples, during impact and piercing of first and second members 402, 404, a metallurgical bond may be formed between first and second members 402, 404, e.g. at surficial interfaces of the members on either side of nail 416.

The metallurgical bond between first and second members 402, 404 is illustrated in FIGS. 4B-4D, which depict shearing of the members during the nailing procedure. Due to the high threshold velocity of striker 414 and nail 416, the rate of shear of members 402, 404 is also high and, in some examples, sufficiently high to induce a metallurgical bond at surficial interfaces of the members caused by adiabatic shear instability and/or high frictional forces.

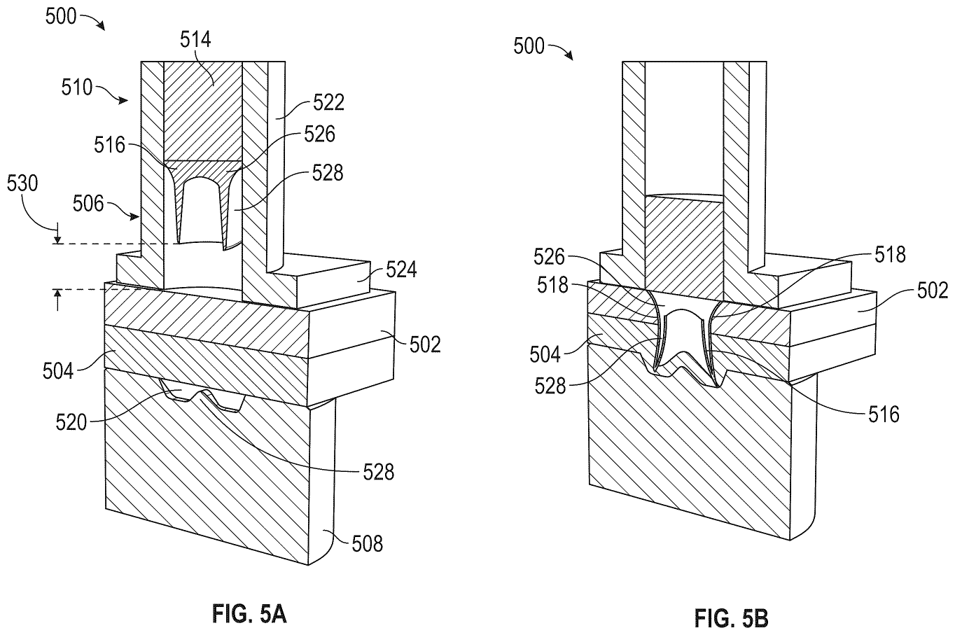

FIGS. 5A-5B schematically depict example apparatus 500 for joining a plurality of members, in this example, first member 502 and second member 504. In examples, example method 100 of FIG. 1 and other examples according to this disclosure can be conducted using apparatus 500.

Apparatus 500 includes holder 506 and backing die 508 between which first and second members 502, 504 are clamped. Holder 506 can be a cylinder that also functions to guide projectile 510 accelerated by a prime mover (not shown) to a threshold velocity toward first and second members 502, 504. As depicted, holder 506 can include cylinder 522 in which projectile 510 is arranged and by which the projectile is guided, and base (may also be referred to as shoulder) 524 by which first and second members 502, 504 are clamped between holder 506 and backing die 508.

Projectile 510 in the example of FIGS. 5A-5B includes cylindrical striker 514 and rivet 516. Apparatus 500 of the example of FIGS. 5A-5B is adapted to form a riveted joint between first and second members 502, 504. In the example of FIGS. 5A-5B, rivet 516 is configured to penetrate buy not pierce through both first and second members 502, 504 in the formation of joint 518. In this example, rivet 516 may be similar to rivets employed in what is sometimes referred to as self-piercing rivet (SPR) joints. Rivet 516 includes head 526 and shank 528. Shank 528 is annular and extends from head 526. Rivet 516 can be, e.g., what is sometimes referred to as a hollow self-piercing rivet or hollow SPR.

Backing die 508 can take a variety of forms and, as depicted in the example of FIGS. 5A-5B can include depression 520, into which ends of shank 528 of rivet 516 is received and portions of first and second members 502, 504 are sheared in the formation of a metallurgically bonded joint therebetween. The geometry of depression 520 in backing die 508 (and other backing dies in examples according to this disclosure) can vary depending upon a number of factors and can be varied to improve characteristics of metallurgically bonded joints between members, e.g. first and second members 502, 504.

In the example of FIGS. 5A-5B, a maximum diameter (or other lateral major dimension, e.g. width) of depression 520 is greater than an outer diameter of striker 514 and/or head 526 of rivet 516. Additionally, backing die 508 includes protrusion 528 arranged in and extending upward from a bottom of depression 520. The size and shape of depression 520, and inclusion of protrusion 528 may function to improve characteristics of the high velocity induced metallurgically bonded joint 518 between first and second members 502, 504, and/or rivet 516.

First and second members 502, 504 can be formed from the same or different materials. For example, first and second members 502, 504 can include members formed from the same or different metals and metallic alloys, e.g., aluminum or steel and/or alloys thereof. Additionally, one of the members can be formed from a metal or metallic alloy and another of the members can be formed from a composite. In examples, first and second members 502, 504 can include a material selected from the group of materials consisting of metals, polymers, composites, and combinations thereof.

In examples, the prime mover accelerates striker 514 and rivet 516 to a threshold velocity toward first and second members 502, 504 in stacked relation to one another. Rivet 516 strikes first member 502 at a threshold velocity. It is important that projectile 510, including, in this example, striker 514 and rivet 516 are at the threshold velocity when they strike first member 502. As such, rivet 516 can be arranged spaced apart from first member 502 by gap 530 prior to the prime mover accelerating them toward first and second members 502, 504. Gap 530 is sized such that projectile 510, including striker 514 and rivet 516 can accelerate from a standstill to the threshold velocity before reaching first member 502.

The threshold velocity of projectile 510 is sufficiently high to induce a metallurgical bond in joint 518 connecting first and second members 502, 504. In this example, in which rivet 516 penetrates first and second members 502, 504, the metallurgical bond is formed at the interface between rivet 516 and first and second members 502, 504 along joint 518. There can be a metallurgical bond therefore between rivet 516 and first member 502 and/or a metallurgical bond between rivet 516 and second member 504. Additionally, in some examples, during impact and piercing of first and second members 502, 504, a metallurgical bond may be formed between first and second members 502, 504, e.g. at surficial interfaces of the members on either side of rivet 516 and/or at surficial interfaces of the members in the annulus of shank 528 of rivet 516.

The metallurgical bond between first and second members 502, 504 is illustrated in FIG. 5B, which depict shearing of the members during the riveting procedure. Due to the high threshold velocity of striker 514 and rivet 516, the rate of shear of members 502, 504 is also high and, in some examples, sufficiently high to induce a metallurgical bond at surficial interfaces of the members caused by adiabatic shear instability and/or high frictional forces.

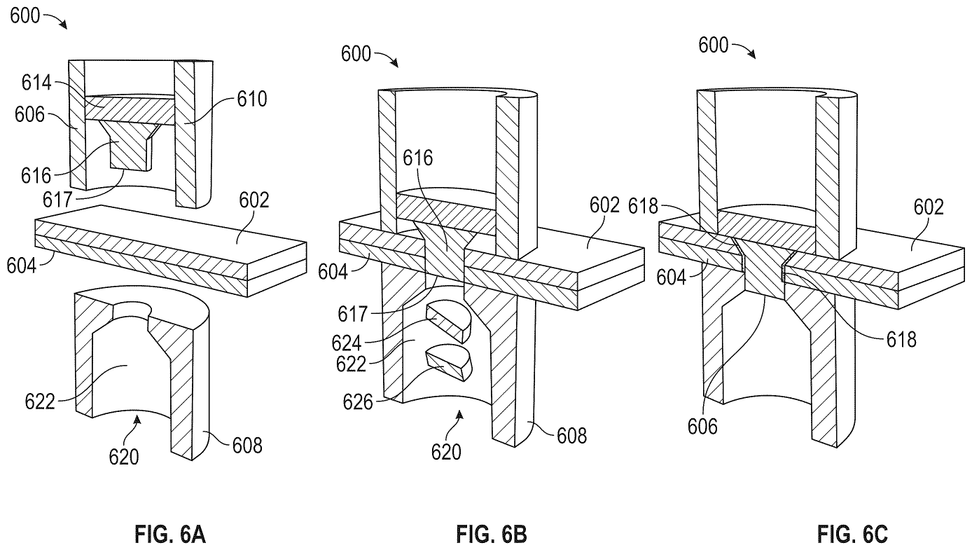

FIGS. 6A-6C schematically depict example apparatus 600 for joining a plurality of members, in this example, first member 602 and second member 604. In examples, example method 100 of FIG. 1 and other examples according to this disclosure can be conducted using apparatus 600.

Apparatus 600 includes holder 606 and backing die 608 between which first and second members 602, 604 are clamped. Holder 606 can be a cylinder that also functions to guide projectile 610 accelerated by a prime mover (not shown) to a threshold velocity toward first and second members 602, 604.

Projectile 610 in the example of FIGS. 6A-6C includes cylindrical striker 614 and fastener 616, which may be a blunt tipped rivet. Apparatus 600 of the example of FIGS. 6A-6C is adapted to form a riveted joint between first and second members 602, 604. In the example of FIGS. 6A-6C, blunt tip 617 of rivet 616 is configured to pierce through first and second members 602, 604 in the formation of joint 618. In this example, rivet 616 may be similar to rivets employed in what is sometimes referred to as self-piercing rivet (SPR) joints. Rivet 516 can be, e.g., what is sometimes referred to as a solid self-piercing rivet or solid SPR. Although rivet 616 is depicted as including a generally straight, cylindrical shank portion, a solid SPR rivet with chamfered (sometimes referred to as chisel) tip can also be employed in examples according to this disclosure. In an example, rivet 616 can include a chamfered blunt tip including a chamfer in a range from greater than zero to approximately 20 degrees.

Backing die 608 can take a variety of forms and, as depicted in the example of FIGS. 6A-6C can include aperture 620, into which rivet 616 is received and, in some examples, into which portions of first and second members 602, 604 are sheared in the formation of a metallurgically bonded joint therebetween. The geometry of aperture 620 in backing die 608 (and other backing dies in examples according to this disclosure) can vary depending upon a number of factors and can be varied to improve characteristics of metallurgically bonded joints between members, e.g. first and second members 602, 604. For example, aperture 620 of backing die includes enlarged section 622 to assist in clear waste sections 624, 626 of first and second members 602, 604 punched from the members by blunt tip 617 of rivet 616.

First and second members 602, 604 can be formed from the same or different materials. For example, first and second members 602, 604 can include members formed from the same or different metals and metallic alloys, e.g., aluminum or steel and/or alloys thereof. Additionally, one of the members can be formed from a metal or metallic alloy and another of the members can be formed from a composite. In examples, first and second members 602, 604 can include a material selected from the group of materials consisting of metals, polymers, composites, and combinations thereof.

In examples, the prime mover accelerates striker 614 and rivet 616 to a threshold velocity toward first and second members 602, 604 in stacked relation to one another. Rivet 616 strikes first member 602 at a threshold velocity. It is important that projectile 610, including, in this example, striker 614 and rivet 616 are at the threshold velocity when they strike first member 602. As such, although not shown in FIG. 6A, rivet 616 can be arranged spaced apart from first member 602 by a gap prior to the prime mover accelerating them toward first and second members 602, 604. The gap is sized such that projectile 610, including striker 614 and rivet 616 can accelerate from a standstill to the threshold velocity before reaching first member 602.

The threshold velocity of projectile 610 is sufficiently high to induce a metallurgical bond in joint 618 connecting first and second members 602, 604. In this example, in which rivet 616 pierces through first and second members 602, 604, the metallurgical bond is formed at the interface between rivet 616 and first and second members 602, 604 along joint 618. There can be a metallurgical bond therefore between rivet 616 and first member 602 and/or a metallurgical bond between rivet 616 and second member 604. Additionally, in some examples, during impact and piercing of first and second members 602, 604, a metallurgical bond may be formed between first and second members 602, 604, e.g. at surficial interfaces of the members on either side of rivet 616.

FIGS. 7A-7B schematically depict example apparatus 700 for joining a plurality of members, in this example, first member 702 and second member 704. In examples, example method 100 of FIG. 1 and other methods according to this disclosure can be conducted using apparatus 700. Apparatus 700 includes holder 706 and backing die 708 between which first and second members 702, 704 are clamped.

Holder 706 can be a cylinder that also functions to guide projectile 710 accelerated by a prime mover (not shown) to a threshold velocity toward first and second members 702, 704. As depicted, holder 706 can include cylinder 714 in which projectile 710 is arranged and by which the projectile is guided, and base (may also be referred to as shoulder) 716 by which first and second members 702, 704 are clamped between holder 706 and backing die 708.

Backing die 708 can take a variety of forms and, as depicted in the example of FIGS. 7A-7B can include depression 720, into which portions of first and second members 702, 704 are sheared in the formation of a metallurgically bonded joint therebetween. The geometry of depression 720 in backing die 708 (and other backing dies in examples according to this disclosure) can vary depending upon a number of factors and can be varied to improve characteristics of metallurgically bonded joints between members, e.g. first and second members 502, 504.

In the example of FIGS. 7A-7B, a maximum diameter (or other lateral major dimension, e.g. width) of depression 720 is greater than an outer diameter of striker projectile 710. Additionally, backing die 708 includes protrusion 721 arranged in and extending upward from a bottom of depression 720. The size and shape of depression 720, and inclusion of protrusion 721 may function to improve characteristics of the high velocity induced metallurgically bonded joint 718 between first and second members 702, 704.

Projectile 710 in the example of FIGS. 7A-7B includes a cylindrical striker. Projectile striker 710, in this example, also includes chamfered or otherwise tapered striking end 711. Apparatus 700 of the example of FIG. 7 is adapted to form a fastenerless clinch joint between first and second members 702, 704.

First and second members 702, 704 can be formed from the same or different materials. For example, first and second members 702, 704 can include members formed from the same or different metals and metallic alloys, e.g., aluminum or steel and/or alloys thereof. Additionally, one of the members can be formed from a metal or metallic alloy and another of the members can be formed from a composite. In examples, first and second members 702, 704 can include a material selected from the group of materials consisting of metals, polymers, composites, and combinations thereof.

In examples, the prime mover accelerates projectile 710 to a threshold velocity toward first and second members 702, 704 in stacked relation to one another. Projectile 710 strikes first member 702 at the threshold velocity to form joint 718 that couples first and second members 702, 704 to one another. The threshold velocity of projectile 710 is sufficiently high to induce a metallurgical bond in joint 718 between first and second members 702, 704. Additionally, the threshold velocity can be selected to improve the continuity, extent, and/or strength of metallurgically bonded joint 718.

For example, the extent of joint 718 along a surficial interface between first and second members 702, 704 may vary with the threshold velocity selected for projectile 710. For example, at velocities of projectile 710 below 40 meters per second (131.2 feet per second), a metallurgical bond may be formed only at bottom portion 724 or both of opposite side portions 726, 728 of the surficial interface between first and second members 702, 704. In examples, at velocities in a range from approximately 40 meters per second (131.2 feet per second) to approximately 250 meters per second (820.2 feet per second), the metallurgical bond between first and second members 702, 704 may have improved continuity and extent, e.g. may be formed along more of or all of bottom portion 724 and more of or all of side portions 726, 728 of surficial interface 722 between first and second members 702, 704.

In the foregoing example methods and apparatuses of FIGS. 1-7B and other methods and apparatuses according to this disclosure, a plurality of members are joined with high velocity induced metallurgical bonds caused by adiabatic shear instability and/or frictional forces at the surficial joint interface between the members (and between members and fasteners for joints including a fastener). The high velocity interaction of projectile(s) and material members at a joint site between the members produces a shear velocity between the projectile(s) and/or member surfaces resulting in adiabatic shear instability and/or high frictional forces and joint interfacial temperatures and pressures that cause microstructure recrystallization at the interface. Example joints having high velocity induced metallurgical bonds exhibit high strength and other advantageous characteristics and can be produced at scale at relatively low costs with relatively low energy inputs.

In the foregoing example methods and apparatuses of FIGS. 1-7B and other methods and apparatuses according to this disclosure, a “high” velocity that induces metallurgical bonds can vary but is not an unbound or absolutely relative magnitude of velocity. In examples, the velocity is a predetermined threshold velocity greater than a ballistic limit of each of the members being joined and less than a cavitation limit of each of the members. In examples, the threshold velocity can be in a range from approximately 40 meters per second (131.2 feet per second) to approximately 250 meters per second (820.2 feet per second). In examples, the threshold velocity of projectile 210 can be in a range from approximately 90 meters per second (295.3 feet per second) to approximately 250 meters per second (820.2 feet per second). In examples, the threshold velocity can be in a range from approximately 120 meters per second (393.7 feet per second) to approximately 175 meters per second (574 feet per second). In examples, the threshold velocity can be in a range from approximately 120 meters per second (393.7 feet per second) to approximately 150 meters per second (492.1 feet per second).

The form, number, and materials of the plurality of members joined in the example methods and apparatuses of FIGS. 1-7B and other methods and apparatuses according to this disclosure can vary. For example, the members can include sheets, blocks, billets or other form of components coupled to one another. Additionally, the plurality of members can include two, three, or more members connected to one another. The plurality of members can be formed from the same or different materials. For example, the plurality of members can include members formed from the same or different metals and/or metallic alloys, e.g., aluminum or steel and/or alloys thereof. Additionally, one of the members can be formed from a metal or metallic alloy and another of the members can be formed from a composite. In examples, the members being joined can include a material selected from the group of materials consisting of metals, polymers, composites, and combinations thereof.

The members can be in stacked relation to one another, which can arrange each member such that the member has at least one surface abutting a surface of another member at an interface. For example, in a stack of two members, a first member has a first surface abutting a first surface of the second member at an interface between the two members. In this example, the striker can strike a second surface of the first member opposite the first surface and the joint, including the metallurgical bond can be formed at the interface of the first surfaces of the first and second members, i.e. at the surficial interface between the two members.

In an example including a stack of three members, a first member (e.g. top member) has a first surface abutting a first surface of a second member at a first interface between the first and second members, and the second member (e.g. middle member) has a second surface (opposite the first surface of the second member) abutting a first surface of a third member (e.g. bottom member) at a second interface between the second and third members. In this example, the striker can strike a second surface of the first member opposite the first surface and the joint, including the metallurgical bond can be formed at the interface of the first surfaces of the first and second members, i.e. at the first interface between the first and second members, and/or at the interface of the second surface of the second member and the first surface of the third member, i.e. at the second interface between the second and third members. In example methods and apparatuses according to this disclosure, the joint and the metallurgical bond of the joint can thus include/be formed in different interfacial regions of the plurality of members, including, e.g., surficial interfaces between pairs of members of the plurality of members.

The present inventors have discovered that methods and apparatuses according to this disclosure, including the examples of FIGS. 1-7B can join a variety of combinations of materials in a repeatable, scalable, and efficient process. In examples, one or more of the members being joined can be formed from a variety of cast or wrought metals/metallic alloys, 5XXX, 6XXX, and 7XXX series aluminum alloys, magnesium and magnesium alloys, Polyphthalamide (PPA), polyamide and polyphenylamide plastics, Carbon fiber-reinforced polymers (CFRP), glass, natural, and carbon fiber composites, and various steels and steel alloys, including various advanced high-strength (AHS) and ultra-high-strength (UHS) steels and steel alloys.

Examples according to this disclosure can include joining members comprising austenitic steels/steel alloys, including austenitic steels with a Zinc coating. In examples, one or more members including a steel or steel alloy with greater than or equal to approximately 800 MPa strength can be joined. Examples according to this disclosure can also include joining members including aluminum castings with low ductility, e.g. with a ductility of less than approximately 4%. Such low ductility aluminum castings may also include castings that are not subjected to heat treatment prior to joining.

Additionally, unlike material combination limitations of some current joinery techniques, examples according to this disclosure can include any combination of these various materials, including joining multiple members of the same or different types of metal or metallic alloys, joining multiple members in a combination that includes one or more metal or metallic alloy member and one or more composite members. In an example, one or more aluminum or aluminum alloy members are joined with a composite member. In an example, one or more aluminum or aluminum alloy members are joined with a composite member. In an example, one or more steel or steel alloy members are joined with a composite member.

Methods and apparatuses according to this disclosure, including the examples of FIGS. 1-7B can be employed to join a variety of materials and material combinations. For example, a method and/or apparatus for joining a first and second member can include the following combinations of materials and member thicknesses in TABLE 1.

TABLE 1

| FIRST MEMBER | | | SECOND MEMBER | | |
|---|---|---|---|---|---|
| Material | Thickness | | Material | Thickness | |
| 980 Gen3 Steel Coated | 1.5 to 2 | mm | CR340 Steel | 1.5 | mm |
| 1180 Gen3 Steel Coated | 1.5 to 2 | mm | CR340 Steel | 1.5 | mm |
| Usibor 1500 Steel | 1.8 | mm | Aural 5s F-Temper Aluminum | 3 | mm |
| Usibor 1500 Steel | 1.8 | mm | 6061-T6 Aluminum | 1.6 | mm |
| 7075-T6 Aluminum | 2.5 to 3.5 | mm | 6061-T6 Aluminum | 1.6 | mm |
| Usibor 1500 Steel | 1.8 | mm | CR340 Steel | 1.5 | mm |
| 6061-T6 Aluminum | 3.2 | mm | Aural 5s F-Temper Aluminum | 3 | mm |
| 6061-T6 Aluminum | 1.6 | mm | Aural 5s F-Temper Aluminum | 3 | mm |
| 980 Gen3 Steel Coated | 1.5 to 2 | mm | Aural 5s F-Temper Aluminum | 3 | mm |
| Aural 5s F-Temper Aluminum | 3 | mm | Aural 5s F-Temper Aluminum | 3 | mm |
| EN1706 - AC-43500(AC- | 2.5 | mm | Cr330Y590T Steel | 2.5 | mm |
| AlSi10MnMg)T7 Aluminum | | | | | |
| CR440Y780T-DH-UC-U Steel | 1.3 | mm | Al5_STD_TZ_U Aluminum | 1.2 | mm |

As another example, a method and/or apparatus for joining three members including a first (top) member, second (middle) member, and third (bottom) member can include the following combinations of materials and member thicknesses in TABLE 2.

TABLE 2

| FIRST/TOP MEMBER | | SECOND/MIDDLE MEMBER | | THIRD/BOTTOM MEMBER | |
|---|---|---|---|---|---|
| Material | Thickness | Material | Thickness | Material | Thickness |
| VDA239 - CR5 EG53/ | 0.65 mm | Cr1500 Steel | 1.2 mm | EN1706 - AC-43500(AC- | 2.5 mm |
| 53-E Steel | | | | AlSi10MnMg)T7 | |
| | | | | Aluminum | |
| VDA239 - CR4 EG53/ | 0.7 mm | EN1706 - AC-43500(AC- | 2.8 mm | VDA239 - CR330Y590T- | 1.2 mm |
| 53-E Steel | | AlSi10MnMg)T7 | | DP GI50/50-U Steel | |
| | | Aluminum | | | |
| Cr1500 | 1.4 mm | Cr1500 Steel | 1.2 mm | 6063-T6 Aluminum | 2.5 mm |
| SteelEN10346- | 1.5 mm | EN1706 - AC-43500(AC- | 2.5 mm | EN1706 - AC-43500(AC- | 3 mm |
| 1.0933(HX340LAD) + | | AlSi10MnMg)T7 (C65K F | | AlSi10MnMg)T7 (C65K | |
| Z100-M-B-O | | temper/CCMI T7) | | F temper/CCMI T7, only | |
| | | Aluminum | | 3 mm) Aluminum | |
| SteelEN10346- | 1.6 mm | EN10346- | 0.8 mm | EN1706 - AC-43500(AC- | 2.5 mm |
| 1.0933(HX340LAD) + | | 1.0933(HX340LAD) + | | AlSi10MnMg)T7 | |
| Z100-M-B-O | | Z100-M-B-O Steel | | Aluminum | |
| 5052-T6 Aluminum | 1.27 mm | 5052-T6 Aluminum | 1.27 mm | 6061-T6 Aluminum | 1.27 mm |
| CR340LA GI50/50-U | 1.5 mm | Al5_STD_TZ_U | 1.2 mm | Al5_STD_TZ_U | 2 mm |
| Steel | | Aluminum | | Aluminum | |
| VDA239 - CR4 EG53/ | 0.7 mm | Coated DP590 Steel | 1.9 mm | 5052-T6 Aluminum | 1.27 mm |
| 53-E Steel | | | | | |

Methods and apparatuses according to this disclosure, including the examples of FIGS. 1-7B can be employed to join a first and second member including the following combinations of materials and member thicknesses in TABLE 3.

TABLE 3

| | |
|---|---|
| FIRST MEMBER | SECOND MEMBER |

| Material | Thickness | Material | Thickness |
|---|---|---|---|
| CR04 | 0.7 mm | PHS1300 | 1.5 mm |
| PHS1300 | 1.5 mm | PHS1300 | 1.5 mm |
| CR04 | 0.7 mm | DP980 | 1.1 mm |
| RA1180 | 1.2 mm | PHS1300 | 1.5 mm |
| CR04 | 0.7 mm | RA1180 | 1.2 mm |
| DP590 | 1 mm | RA1180 | 1.6 mm |
| DP590 | 1 mm | PHS1300 | 1.5 mm |

Example methods and apparatuses according to this disclosure are agnostic to the stacking order of members being joined. Thus, although the examples of TABLE 2 include a first (top) member, second (middle) member, and third (bottom) member, each combination of three members could also be stacked in a different order. As another example, in a two-member joint of aluminum and steel, examples according to this disclosure can join these two members regardless if the aluminum or steel member is the top member or bottom member. As another example including joining three members including two metallic members and a composite member, the stacking order can be top metallic, middle composite, bottom metallic, or top metallic, middle metallic, bottom composite, or top composite, middle metallic, bottom metallic. Any order of any combination of members (including the example combinations set forth above) is possible.

Example methods and apparatuses according to this disclosure can be capable of reliably and repeatably joining a plurality of members in a larger range of member and/or stack thicknesses than other available joinery methods. For example, certain high strength steels, e.g. 1300 MPa steels joined using some currently available techniques may be limited to thicknesses on the order of 2 mm. As another example, certain Aluminum alloys joined using some currently available techniques may be limited to thicknesses on the order of 3 to 4 mm. At least some examples according to this disclosure can metallurgically bond up to and greater than 6.4 mm thick stacks of members.

Example joints formed in methods and by apparatuses according to this disclosure have high velocity induced metallurgical bonds that exhibit high strength and other advantageous characteristics and can be produced at scale at relatively low costs with relatively low energy inputs. Example methods and apparatuses according to this disclosure, including the examples of FIGS. 1-7A may have a number of advantages relative to other techniques. The apparatuses required to form high velocity induced metallurgical bonds between multiple members are relatively simple, amenable to high volume production, and can employ prime movers with relatively low power inputs. These and other factors may enable methods and apparatuses according to this disclosure to join multiple members with a strong, reliable, and repeatable metallurgical bond in cycle times less than or equal to approximately one second. This relatively short cycle time for joining components is substantially shorter than at least some alternative joinery techniques and is also particularly advantageous, and in some cases even perhaps required in certain large volume production industries, e.g. automotive. For example, cycle times of less than or equal to approximately 1 second compares favorably to spot welding cycle times, which can have cycle times of approximately 1-approximately 1.5 seconds for steel and approximately 2-approximately 2.5 seconds for aluminum, and to self-pierce riveting, which can have cycle times of approximately 1 to approximately 2 seconds.

Additionally, as noted examples according to this disclosure can include pre and/or post-processing including, e.g., surface preparation and/or adhesives. However, such additional processing steps are not required in examples according to this disclosure to form a quality high velocity induced metallurgical bond between multiple members. For example, in certain joinery techniques of certain materials, pre-processing the members being joined may be required, including, e.g., plasma cleaning/decontaminating joint interfacial surfaces of the members. In joining members that include or are contaminated with zinc on the surfaces of the members or fastener used in the joint, plasma surface cleaning or another technique may be required to remove the zinc coating. For example, such pre-processing may be required in resistance spot welding, as during the welding the zinc coating may undergo liquid metal embrittlement (LME) which can compromise the integrity of the joint being formed.

Examples according to this disclosure, however, join members with or without a fastener with a metallurgical bond that is formed in solid phase plastic deformation of the members and, in relevant examples, fastener. In such cases, zinc or other material coating/contaminant subject to LME does not liquify and therefore does not become embrittle during joining of the members. Thus, in examples according to this disclosure, members being joined and/or fasteners employed in such joining can but do not need to include a surface coating, e.g., an anticorrosion coating like Zinc based coating. Due to the mechanism(s) by which the metallurgical bond between members and/or fastener is formed, LME may not occur thus allowing such coatings in examples according to this disclosure.

The relative small size of joints between members joined in accordance with examples of this disclosure can also produce advantages. For example, some spot-welded joints may on the order of approximately 5 to 6 mm, which can impose an approximately 16 to 20 mm width requirement on the members being joined (sometimes referred to flange width). By reducing the joint size and thereby flange width, examples according to this disclosure can reduce costs and environmental burdens of joining members.

Fasteners of various material, subjected to various types of pre-processing, and in various shapes and sizes can be employed in example methods and apparatuses according to this disclosure. In examples, fasteners employed in examples according to this disclosure can include various materials having a strength greater than or equal to approximately 400 MPa. In an example, a 22MnB5 steel fastener can be employed, including, e.g., a 22MnB5 steel with approximately 1.5% by weight Silicone and approximately 2.5% by weight Chromium. In examples, fasteners can include different surface compositions, including, e.g., a surface composition which includes Aluminum, Zinc, and/or Silicone. In an example, a fastener can include a surface composition having 55% by weight Aluminum, 43.5% by weight Zinc, and 1.5% by weight Silicone.

It may be important that fasteners employed in joining of multiple members in example methods and apparatuses according to this disclosure include head portion that has a diameter greater than a shank or other penetrating and/or piercing portion of the fastener. Such larger diameter head to limit or prevent penetration of the upper portion of the fastener into the upper/top member being joined. In examples, a fastener includes a head and a shank. The head can include a first diameter and the shank a second diameter that is less than the first diameter. The head can have different shapes/configurations, including, e.g. countersink, button, and/or flat.

Some examples according to this disclosure may require more intimate interfacial surface contact than other joinery methods. As such, it may be important to employ fasteners with relatively smooth outer surfaces and/or fine surface finishes to achieve or improve metallurgical bonds between the fastener and the members being joined. In examples, a fastener is employed which does not include threads, undulations, convolutions, or other macroscopic surface irregularities/protrusions/features on the outer surfaces of the fastener at the interface of a joint between the fastener and a plurality of members.

Examples according to this disclosure may also enable use of certain materials and/or material combinations not possible with other joinery techniques. For example, in resistance spot welding, sheet member stacks which include Zn-coated steel with microstructure with a fraction percentage of austenite cannot be spot welded due to cracks associated with LME imposed by the presence of molten zinc under pressure. Additionally, sheet member stacks which include steel and aluminum may be limited to 2 sheets, due to the difference in electrical resistance and range in melting point temperatures. Sheet member stacks that include an aluminum or steel sheet cannot include a composite material sheet due to the difference in electrical resistance, range in melting point temperatures and lack of solubility. As another example, sheet stacks which include a 1,500 MPa and 2,000 MPa martensitic steel may result in weld cracks and reduced strength in the joint.

In SPR, top and bottom sheet members may be limited to a heat treated cast form or wrought sheet with strength of less than approximately 800 MPa. Sheet stacking order may be limited to high strength (hard) material on top and low strength (soft), high ductility material on bottom. 7xxx series aluminum sheet may not be joined using due to high strength, low ductility and susceptibility to stress corrosion cracking imposed by process related stress. Aluminum sheet stacks may be limited to 3 sheets and steel sheet stacks may be limited to 2 sheets. The maximum strength of the upper sheet stack may be limited to approximately 250 MPa, and the bottom sheet requires minimum 8% ductility to avoid cracking. Multimaterial steel/aluminum sheet stacks may be limited to 2 sheets and the steel sheet may need be the top sheet, have less than approximately 800 MPa strength, be less than approximately 2 mm thick. Steel rivets may be required in some applications to join high strength sheet member(s), e.g., steel sheet stacks and aluminum and steel sheet stacks. Such steel rivets can include disadvantageous corrosive coatings.

Clinch mechanical interlock joints may require sheet materials with minimum 10% total elongation and a strain hardening exponent of less than approximately 0.22, limiting material strength to sheet stacks which include material with strengths of less than approximately 700 MPa. Such mechanical joints can also be on the order of three times less than SPR and spot weld joints, limiting their use to non-structural applications. Clinch-style mechanical interlock joints can also impose galvanic corrosion issues, limiting applications to dry surfaces not exposed to moisture. Clinch-style mechanical interlock joints may also require a minimum flange width three times the punch diameter, limiting environmental and cost benefit associated with flange width reduction. And these types of mechanical joints can a high punch force, based on material strength, thickness and bottom die geometry.

Examples according to this disclosure may provide a number of advantages relative to, e.g., spot welding, SPR, and/or clinch mechanical interlock joints. For example, relative to spot welding, examples according to this disclosure may enable: joining of multi-sheet stacks of wrought aluminum, and stacks of cast steel and aluminum; joining of multimaterial sheet stacks; joining of Zn-coated steel parts with austenitic microstructure while avoiding LME; assembly of sheet stacks which include thermoset composite members; and assembly of sheet stacks which incorporate use of a non-conductive structural adhesive to increase joint strength and fatigue life.

Relative to SPR, examples according to this disclosure may enable: joining of multi-sheet stacks of wrought aluminum, and stacks of cast steel and aluminum; joining of multimaterial sheet stacks; joining of Zn-coated steel parts with austenitic microstructure while avoiding LME; assembly of sheet stacks which include thermoset composite members; and assembly of sheet stacks which incorporate use of a non-conductive structural adhesive to increase joint strength and fatigue life; assembly of sheet stacks which include sheet having strength of up to approximately 2,000 MPa; assembly of sheet stacks, independent of hard/soft stacking order requirements; assembly of sheet stacks which include 7xxx aluminum sheet and thermoset composite sheet; and assembly of sheet stacks which include up to 5 sheet members.

And relative to mechanical clinch joints, examples according to this disclosure may enable: joining of higher strength multi-sheet stacks of wrought aluminum, cast steel and aluminum, and zinc-coated GEN3 steels; assembly of sheet stacks which include sheet having strength of up to approximately 2,000 MPa; assembly of sheet stacks which include lower ductility sheet; assembly of sheet stacks which include 7XXX aluminum; assembly of sheet stacks which include AHSS and UHSS; and assembly of sheet stacks, independent of hard/soft stacking order requirements. Additionally, examples according to this disclosure may mitigate galvanic, filiform, and crevice corrosion relative to mechanical clinch joints.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The present application provides for the following exemplary embodiments or examples, the numbering of which is not to be construed as designating levels of importance:

Example 1 provides a method of comprising: accelerating a projectile to a threshold velocity toward a plurality of members in stacked relation to one another; and striking a first member of the plurality of members at or above a threshold velocity with the projectile to form a joint that couples the plurality of members to one another, wherein the threshold velocity is sufficient to induce a metallurgical bond in the joint.

Example 2 provides the method of Example 1 and optionally wherein the plurality of members comprise the same material composition.

Example 3 provides the method of Example 1 and optionally wherein the plurality of members comprise different material compositions.

Example 4 provides the method of Example 1 and optionally wherein the plurality of members comprise materials selected from the group consisting of metals, polymers, composites, and combinations thereof.

Example 5 provides the method of Example 1 and optionally wherein one of the plurality of members comprises an aluminum alloy and another of the plurality of members comprises a steel alloy.

Example 6 provides the method of Example 1 and optionally wherein the plurality of members comprise materials selected from the group consisting of 5XXX, 6XXX, and 7XXX aluminum alloys and combinations thereof.

Example 7 provides the method of Example 1 and optionally wherein one of the plurality of members comprises an aluminum alloy and another of the plurality of members comprises a composite.

Example 8 provides the method of Example 1 and optionally wherein one of the plurality of members comprises a steel alloy and another of the plurality of members comprises a composite.

Example 9 provides the method of Example 1 and optionally wherein one or more of the plurality of members comprises an austenitic steel.

Example 10 provides the method of Example 1 and optionally wherein one or more of the plurality of members comprises steel having a strength of greater than or equal to approximately 800 MPa.

Example 11 provides the method of Example 1 and optionally wherein one or more of the plurality of members comprises an aluminum casting having less than or equal to approximately 4% ductility.

Example 12 provides the method of Example 1 and optionally wherein the one or more of the plurality of members comprising the aluminum casting are not heat treated.

Example 13 provides the method of any of Examples 1-12 and optionally wherein the threshold velocity is in a range from approximately 40 meters per second to approximately 250 meters per second.

Example 14 provides the method of any of Examples 1-13 and optionally wherein the threshold velocity is in a range from approximately 90 meters per second to approximately 250 meters per second.

Example 15 provides the method of any of Examples 1-14 and optionally wherein the threshold velocity is in a range from approximately 120 meters per second to approximately 175 meters per second.

Example 16 provides the method of any of Examples 1-15 and optionally wherein the threshold velocity is in a range from approximately 120 meters per second to approximately 150 meters per second.

Example 17 provides the method of any of the Examples 1-16 and optionally wherein the threshold velocity is greater than a ballistic limit of each of the plurality of members and less than a cavitation limit of each of the plurality of members.

Example 15 provides the method of any of the Examples 1-17 and optionally wherein the projectile comprises a striker and a fastener, and further comprising: arranging the striker and the fastener adjacent the first member of the plurality of members; accelerating the striker and the fastener together to the threshold velocity toward the first member; and striking the first member at the threshold velocity with the striker and the fastener to form the joint, wherein the joint couples the plurality of members and the fastener.

Example 16 provides the method of Example 15 and optionally wherein the joint comprises a mechanical joint between the fastener and one or more of the plurality of members.

Example 17 provides the method of Example 15 and optionally wherein the metallurgical bond of the joint comprises a metallurgical bond between the fastener and one or more of the plurality of members.

Example 18 provides the method of Example 15 and optionally further comprising penetrating one or more of the plurality of members with the fastener.

Example 19 provides the method of Example 18 and optionally wherein: the fastener comprises a nail having a pointed end; and penetrating each of the plurality of members comprises piercing each of the plurality of members with the nail.

Example 20 provides the method of Example 19 and optionally wherein: the fastener comprises a rivet; and penetrating each of the plurality of members comprises penetrating but not piercing all of the plurality of members with the rivet.

Example 21 provides the method of Example 20 and optionally wherein the rivet comprises a hollow self-piercing rivet.

Example 22 provides the method of Example 18 and optionally wherein: the fastener comprises a solid rivet having a blunt end; and penetrating each of the plurality of members comprises piercing each of the plurality of members with the solid rivet.

Example 23 provides the method of any of the Examples 15-22 and optionally wherein: the fastener comprises a head and a shank extending from the head; and the head comprises a larger cross-sectional area than a cross-sectional area of the shank.

Example 24 provides the method of any of the Examples 15-23 and optionally wherein the striker comprises a larger cross-sectional area than a cross-sectional area of the fastener.

Example 25 provides the method of any of the Examples 15-23 and optionally wherein: arranging the striker and the fastener adjacent the first member of the plurality of members comprises arranging the fastener spaced apart from the first member by a gap; and the gap is sized such that the striker and the fastener can accelerate from a standstill to or above the threshold velocity before reaching the first member.

Example 26 provides the method of any of the Examples 1-25 and optionally further comprising plasma surface treating one or more surfaces of each of the plurality of members prior to metallurgically bonding the plurality of members to one another.

Example 27 provides the method of any of the Examples 1-26 and optionally further comprising applying an adhesive to one or more surfaces of each of the plurality of members prior to metallurgically bonding the plurality of members to one another.

Example 28 provides the method of any of the Examples 1-25 and optionally further comprising: plasma surface treating one or more surfaces of each of the plurality of members; and applying an adhesive to the one or more surfaces of each of the plurality of members.

Example 29 provides an apparatus for joining a plurality of members, the apparatus comprising: a holder configured to secure the plurality of members in stacked relation to one another; a projectile; and a prime mover arranged and configured to accelerate the projectile toward the plurality of members such that the projectile strikes a first member of the plurality of members at or above a threshold velocity to form a joint that couples the plurality of members to one another, wherein the threshold velocity is sufficient to induce a metallurgical bond in the joint.

Example 30 provides the apparatus of Example 29 and optionally further comprising a backing die, wherein the holder and backing die are in stacked relation to one another and configured to clamp the plurality of members therebetween.

Example 31 provides the apparatus of Example 29 and optionally wherein the plurality of members comprise the same material composition.

Example 32 provides the apparatus of Example 29 and optionally wherein the plurality of members comprise different material compositions.

Example 33 provides the apparatus of Example 29 and optionally wherein the plurality of members comprise materials selected from the group consisting of metals, polymers, composites, and combinations thereof.

Example 34 provides the apparatus of Example 29 and optionally wherein one of the plurality of members comprises an aluminum alloy and another of the plurality of members comprises a steel alloy.

Example 35 provides the apparatus of Example 29 and optionally wherein the plurality of members comprise materials selected from the group consisting of 5XXX, 6XXX, and 7XXX aluminum alloys and combinations thereof.

Example 36 provides the apparatus of Example 29 and optionally wherein one of the plurality of members comprises an aluminum alloy and another of the plurality of members comprises a composite.

Example 37 provides the apparatus of Example 29 and optionally wherein one of the plurality of members comprises a steel alloy and another of the plurality of members comprises a composite.

Example 38 provides the apparatus of Example 29 and optionally wherein one or more of the plurality of members comprises an austenitic steel.

Example 39 provides the apparatus of Example 29 and optionally wherein one or more of the plurality of members comprises steel having a strength of greater than or equal to approximately 800 MPa.

Example 40 provides the apparatus of Example 29 and optionally wherein one or more of the plurality of members comprises an aluminum casting having less than or equal to approximately 4% ductility.

Example 41 provides the apparatus of Example 29 and optionally wherein the one or more of the plurality of members comprising the aluminum casting are not heat treated.

Example 42 provides the apparatus of any of Examples 29-41 and optionally wherein the threshold velocity is in a range from approximately 40 meters per second to approximately 250 meters per second.

Example 43 provides the apparatus of any of Examples 29-42 and optionally wherein the threshold velocity is in a range from approximately 90 meters per second to approximately 250 meters per second.

Example 44 provides the apparatus of any of Examples 29-43 and optionally wherein the threshold velocity is in a range from approximately 120 meters per second to approximately 175 meters per second.

Example 45 provides the apparatus of any of Examples 29-44 and optionally wherein the threshold velocity is in a range from approximately 120 meters per second to approximately 150 meters per second.

Example 46 provides the apparatus of any of Examples 29-45 and optionally wherein the threshold velocity is greater than a ballistic limit of both the first member and the second member and less than a cavitation limit of both the first member and the second member.

Example 47 provides the apparatus of any of Examples 29-46 and optionally wherein: the projectile comprises a striker and a fastener; and the prime mover is arranged and configured to accelerate the striker and the fastener together to the threshold velocity toward the first member such that the striker and the fastener strike the first member at or above the threshold velocity to form the joint; and the joint couples the first member, the second member, and the fastener.

Example 48 provides the apparatus of Example 47 and optionally wherein the joint comprises a mechanical joint between the fastener and one or more of the plurality of members.

Example 49 provides the apparatus of Example 47 and optionally wherein the metallurgical bond of the joint comprises a metallurgical bond between the fastener and one or more of the plurality of members.

Example 50 provides the apparatus of Example 47 and optionally wherein the prime mover is arranged and configured to accelerate the striker and the fastener together to or above the threshold velocity toward the first member such that the fastener penetrates one or more of the plurality of members.

Example 51 provides the apparatus of Example 47 and optionally wherein: the fastener comprises a nail having a pointed end; and the prime mover is arranged and configured to accelerate the striker and the nail together to or above the threshold velocity toward the first member such that the nail pierces the plurality of members.

Example 52 provides the apparatus of Example 47 and optionally wherein: the fastener comprises a rivet; and the prime mover is arranged and configured to accelerate the striker and the rivet together to or above the threshold velocity toward the first member such that the rivet penetrates but does not pierce all of the plurality of members.

Example 53 provides the apparatus of Example 52 and optionally wherein the rivet comprises a hollow self-piercing rivet.

Example 54 provides the apparatus of Example 47 and optionally wherein: the fastener comprises a solid rivet having a blunt end; and the prime mover is arranged and configured to accelerate the striker and the solid rivet together to or above the threshold velocity toward the first member such that the solid rivet pierces the plurality of members.

Example 55 provides the apparatus of Example 54 and optionally wherein the blunt end of the solid rivet comprises a chamfer.

Example 56 provides the apparatus of any of examples Example 47-55 and optionally wherein: the fastener comprises a head and a shank extending from the head; and the head comprises a larger cross-sectional area than a cross-sectional area of the shank.

Example 57 provides the apparatus of any of examples Example 47-56 and optionally wherein the striker comprises a larger cross-sectional area than a cross-sectional area of the fastener.

Example 58 provides a method comprising: accelerating a projectile to a threshold velocity toward a plurality of members in stacked relation to one another; and striking a first member of the plurality of members at a threshold velocity with the projectile to metallurgically bond the plurality of members to one another, wherein the method takes less than or equal to approximately one second.

Example 59 provides a method comprising: accelerating a projectile to a threshold velocity toward a plurality of members in stacked relation to one another; and striking a first member of the plurality of members at a threshold velocity with the projectile to metallurgically bond the plurality of members to one another, wherein surfaces of each of the plurality of members do not require a surface preparation process prior to metallurgically bonding the plurality of members to one another.

Example 60 provides the method of Example 59 and optionally wherein surfaces of each of the plurality of members are not subjected to a surface preparation process prior to metallurgically boding the plurality of members to one another.

Various aspects of the disclosure have been described. These and other aspects are within the scope of the following claims.

1. A method comprising:
accelerating a projectile to a threshold velocity toward a plurality of members in stacked relation to one another; and
striking a first member of the plurality of members at or above the threshold velocity with the projectile to form a joint that couples the plurality of members to one another,
wherein the threshold velocity is sufficient to induce a metallurgical bond in the joint, and
wherein the threshold velocity is greater than a ballistic limit and less than a cavitation limit of each of the plurality of members.

2. The method of claim 1, wherein the plurality of members comprise the same material composition.

3. The method of claim 1, wherein the plurality of members comprise different material compositions.

4. The method of claim 1, wherein the plurality of members comprise materials selected from the group consisting of metals, polymers, composites, and combinations thereof.

5. The method of claim 1, wherein the threshold velocity is in a range from approximately 40 meters per second to approximately 250 meters per second.

6. The method of claim 1, wherein the threshold velocity is in a range from approximately 90 meters per second to approximately 250 meters per second.

7. The method of claim 1, wherein the threshold velocity is in a range from approximately 120 meters per second to approximately 175 meters per second.

8. The method of claim 1, wherein the threshold velocity is in a range from approximately 120 meters per second to approximately 150 meters per second.

9. The method of claim 1, wherein the projectile comprises a striker and a fastener, and further comprising:
arranging the striker and the fastener adjacent the first member of the plurality of members;
accelerating the striker and the fastener together to the threshold velocity toward the first member; and
striking the first member at the threshold velocity with the striker and the fastener to form the joint, wherein the joint couples the plurality of members and the fastener.

10. An apparatus for joining a plurality of members, the apparatus comprising:
a holder configured to secure the plurality of members in stacked relation to one another;
a projectile; and
a prime mover arranged and configured to accelerate the projectile toward the plurality of members such that the projectile strikes a first member of the plurality of members at or above a threshold velocity to form a joint that couples the plurality of members to one another,
wherein the threshold velocity is sufficient to induce a metallurgical bond in the joint, and
wherein the threshold velocity is greater than a ballistic limit and less than a cavitation limit of each of the plurality of members.

11. The apparatus of claim 10, further comprising a backing die, wherein the holder and backing die are in stacked relation to one another and configured to clamp the plurality of members therebetween.

12. The apparatus of claim 10, wherein the plurality of members comprise the same material composition.

13. The apparatus of claim 10, wherein the plurality of members comprise different material compositions.

14. The apparatus of claim 10, wherein the plurality of members comprise materials selected from the group consisting of metals, polymers, composites, and combinations thereof.

15. The apparatus of claim 10, wherein the threshold velocity is in a range from approximately 40 meters per second to approximately 200 meters per second.

16. The apparatus of claim 10, wherein the threshold velocity is in a range from approximately 120 meters per second to approximately 150 meters per second.

17. The apparatus of claim 10, wherein:
the projectile comprises a striker and a fastener; and
the prime mover is arranged and configured to accelerate the striker and the fastener together to the threshold velocity toward the first member such that the striker and the fastener strike the first member at or above the threshold velocity to form the joint; and
the joint couples the first member, the second member, and the fastener.

18. The apparatus of claim 17, wherein:
the fastener comprises a nail having a pointed end; and
the prime mover is arranged and configured to accelerate the striker and the nail together to or above the threshold velocity toward the first member such that the nail pierces the plurality of members.

19. The apparatus of claim 17, wherein:
the fastener comprises a rivet; and
the prime mover is arranged and configured to accelerate the striker and the rivet together to or above the threshold velocity toward the first member such that the rivet penetrates but does not pierce all of the plurality of members.

20. The apparatus of claim 17, wherein:
the fastener comprises a solid rivet having a blunt end; and
the prime mover is arranged and configured to accelerate the striker and the solid rivet together to or above the threshold velocity toward the first member such that the solid rivet pierces the plurality of members.

21. The apparatus of claim 17, wherein:
the fastener comprises a head and a shank extending from the head; and
the head comprises a larger cross-sectional area than a cross-sectional area of the shank.

22. The apparatus of claim 17, wherein the striker comprises a larger cross-sectional area than a cross-sectional area of the fastener.

23. (canceled)
